(19) United States
(12) Patent Application Publication
(10) Pub. No.: US 2026/0358134 A1
(43) Pub. Date: Nov. 12, 2026

(54) PARKING LOT RECOMMENDATION SYSTEM

(71) Applicant: NTT DOCOMO, INC., Tokyo (JP)

(72) Inventors: Ryou KOYAMA, Tokyo (JP); Shin ISHIGURO, Tokyo (JP); Takashi SUZUKI, Tokyo (JP); Akira YAMADA, Tokyo (JP)

(73) Assignee: NTT DOCOMO, INC., Tokyo (JP)

(21) Appl. No.: 19/153,441

(22) PCT Filed: Jan. 26, 2024
(86) PCT No.: PCT/JP2024/002499

§ 371 Date: Aug. 4, 2025

(30) Foreign Application Priority Data
Mar. 27, 2023 (JP) 2023-050002

(51) Int. Cl. G01C 21/36

(52) U.S. Cl. CPC G01C 21/3685; G01C 21/3617

(57) ABSTRACT

A parking lot recommendation system includes a destination information acquisition unit that acquires destination information indicating a location of a user's destination, a visiting place estimation unit that estimates a location of an estimated visiting place to be visited by the user based on the destination information, a parking lot information acquisition unit that acquires parking lot information indicating the location of a parking lot, and a parking lot determination unit that performs determination regarding the parking lot to be recommended to the user based on movement along a route including the location of the destination indicated by the destination information, the location of the estimated visiting place, and the location of the parking lot indicated by the parking lot information.

### TECHNICAL FIELD

The present disclosure relates to a parking lot recommendation system.

### BACKGROUND ART

In the related art, there is a parking lot recommendation system disclosed in Patent Literature 1 as a system that presents a recommended parking lot to a user. This parking lot recommendation system searches for a route from a departure point to a destination, specifies transit facilities on the found route, and specifies a plurality of parking lots that are near the specified relay facilities. This parking lot recommendation system specifies, as a recommended parking lot, a parking lot that is selected from among the plurality of specified parking lots in consideration of a time required to park in the parking lot, a time it takes for a user to arrive at a relay facility after parking, and a time incurred due to traffic congestion, and the like.

### CITATION LIST

### Patent Literature

[Patent Literature 1] Japanese Unexamined Patent Publication No. 2012-202920

### SUMMARY OF INVENTION

### Technical Problem

A user may visit a plurality of facilities while using one parking lot. Although the above-mentioned parking lot recommendation system recommends parking lots in consideration of movement between a departure point, relay facilities, and a parking lot, it does not take into account that a plurality of facilities are visited as destinations (rather than relay locations) while using one parking lot. Thus, there is a possibility that the above-mentioned parking lot recommendation system will recommend a parking lot that is not appropriate for a user in the above-mentioned cases and the like.

The present disclosure has been made in consideration of the above circumstances, and an object thereof is to provide a parking lot recommendation system that can recommend a parking lot appropriate for users.

### Solution to Problem

In order to achieve the above-mentioned object, a parking lot recommendation system according to the present disclosure includes a destination information acquisition unit that acquires destination information indicating a location of a user's destination, a visiting place estimation unit that estimates a location of an estimated visiting place to be visited by the user based on the destination information, a parking lot information acquisition unit that acquires parking lot information indicating a location of a parking lot, and a parking lot determination unit that performs determination regarding the parking lot to be recommended to the user, based on movement along a route including the location of the destination indicated by the destination information, the location of the estimated visiting place, and the location of the parking lot indicated by the parking lot information.

In the parking lot recommendation system according to the present disclosure, determination regarding a parking lot to be recommended to a user is performed based on movement along a route including the location of the user's destination, the location of the estimated visiting place, and the location of the parking lot. For example, determination regarding a parking lot to be recommended to a user can be performed to reduce the burden when moving along the route including the destination, the estimated visiting place, and the parking lot. Since determination regarding a parking lot can be performed in consideration of all positional relationships between the destination, the estimated visiting place, and the parking lot, an appropriate parking lot can be recommended to the user.

### Advantageous Effects of Invention

According to the present disclosure, it is possible to recommend a parking lot appropriate for users.

### BRIEF DESCRIPTION OF DRAWINGS

FIG. 1 is a diagram showing the configuration of a parking lot recommendation system according to an embodiment of the present disclosure.

FIG. 2 is a schematic diagram showing a positional relationship between a destination, an estimated visiting place, and a parking lot.

FIG. 3 is a diagram showing an example of tables stored in a POI database, a parking lot database, and a visitor database.

FIG. 4 is a diagram showing an example of a method of generating an estimated visiting place database.

FIG. 5 is a diagram showing an example of a method of generating a selection probability database.

FIG. 6 is a diagram showing an example of the display of recommended parking lots.

FIG. 7 is a flowchart showing an example of the operation of a parking lot recommendation system according to an embodiment of the present disclosure.

FIG. 8 is a diagram showing a hardware configuration of a parking lot recommendation system according to an embodiment of the present disclosure.

### DESCRIPTION OF EMBODIMENTS

Hereinafter, an embodiment of a parking lot recommendation system according to the present disclosure will be described in detail with reference to the drawings. Note that the same elements are denoted by the same reference numerals in the description of the drawings, and repeated description will be omitted.

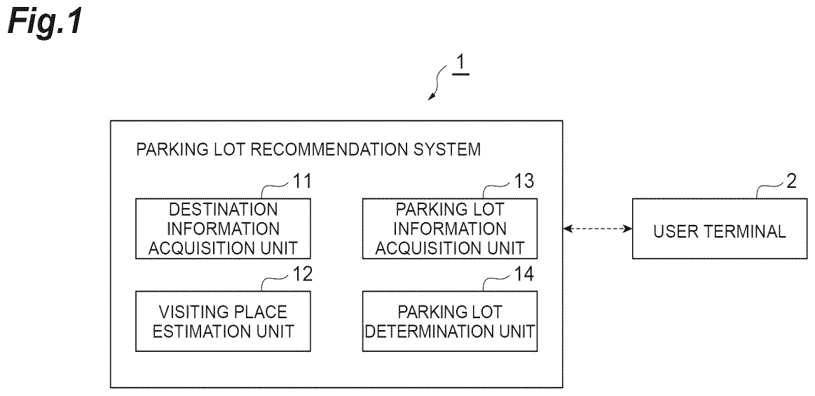

FIG. 1 shows a parking lot recommendation system 1 according to this embodiment. The parking lot recommendation system 1 recommends a parking lot to a user. The parking lot recommendation system 1, for example, presents a parking lot to be recommended to the user. The user is, for example, a person who receives a parking lot recommendation by using the parking lot recommendation system 1.

A parking lot refers to a place where vehicles can be parked. In this embodiment, a parking lot includes a bicycle parking lot where bicycles can be parked. A parking lot is not necessarily limited to a place used exclusively for parking vehicles, and may be a place located near a commercial facility such as a convenience store and where vehicles can be parked.

The parking lot recommendation system 1 is configured with a computer such as a personal computer (PC) or a server device having a communication function. The parking lot recommendation system 1 may be configured with a plurality of computers, that is, a computer system. The parking lot recommendation system 1 can transmit and receive information to and from a user terminal 2 via a network such as a mobile communications network.

The user terminal 2 is a terminal used by a user. The user terminal 2 is, for example, a smartphone or a tablet terminal carried by the user, and is used to recommend a parking lot to the user. The user terminal 2 may be, for example, an in-vehicle terminal that is installed in a vehicle in which the user rides and included in a car navigation system. The user terminal 2 may be a terminal similar to a user terminal of the related art.

For example, destination information indicating the location of the user's destination is input into the user terminal 2 by the user. A destination is, for example, a location where the user desires to arrive. The user terminal 2 transmits the destination information input by the user to the parking lot recommendation system 1.

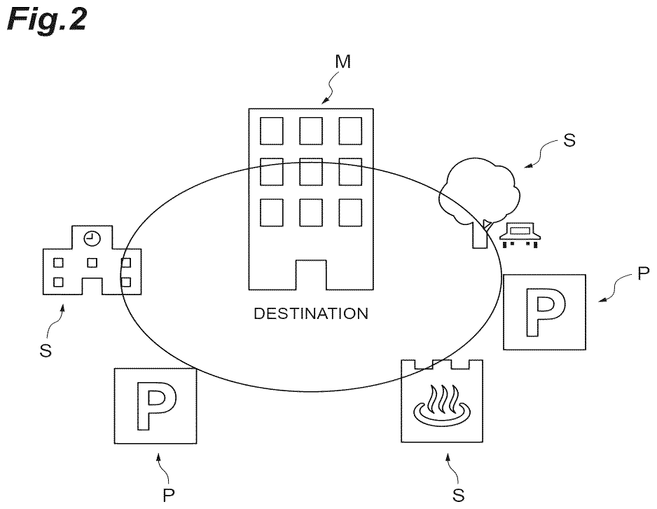

FIG. 2 is a schematic diagram showing a positional relationship between a destination M, an estimated visiting place S, and a parking lot P. For example, the estimated visiting place S and the parking lot P are located in the vicinity of the destination M. The estimated visiting place S is, for example, a place that is estimated to be visited by a person who visits the destination M. For example, when the user's destination Mis a tourist spot such as a temple, the estimated visiting place S is another tourist spot related to that tourist spot.

While the user is using one parking lot P, the user may visit not only the destination M but also the estimated visiting place S that is different from the destination M. For this reason, when the parking lot P is recommended to the user, it is desirable to consider visiting both the destination M and the estimated visiting place S. In order to solve such a problem, the parking lot recommendation system 1 according to this embodiment has a configuration to be described below.

Subsequently, the functions of the parking lot recommendation system 1 according to this embodiment will be described. As shown in FIG. 1, the parking lot recommendation system 1 includes a destination information acquisition unit 11, a visiting place estimation unit 12, a parking lot information acquisition unit 13, and a parking lot determination unit 14.

The destination information acquisition unit 11 acquires destination information. In this embodiment, the destination information acquisition unit 11 receives and acquires destination information from the user terminal 2. The destination information includes, for example, the latitude and longitude of the destination M.

The visiting place estimation unit 12 estimates the location of the estimated visiting place S to be visited by a user based on the destination information acquired by the destination information acquisition unit 11. In this embodiment, the visiting place estimation unit 12 estimates the location of the estimated visiting place S based on the destination information, with reference to a POI database DB1 to be described below.

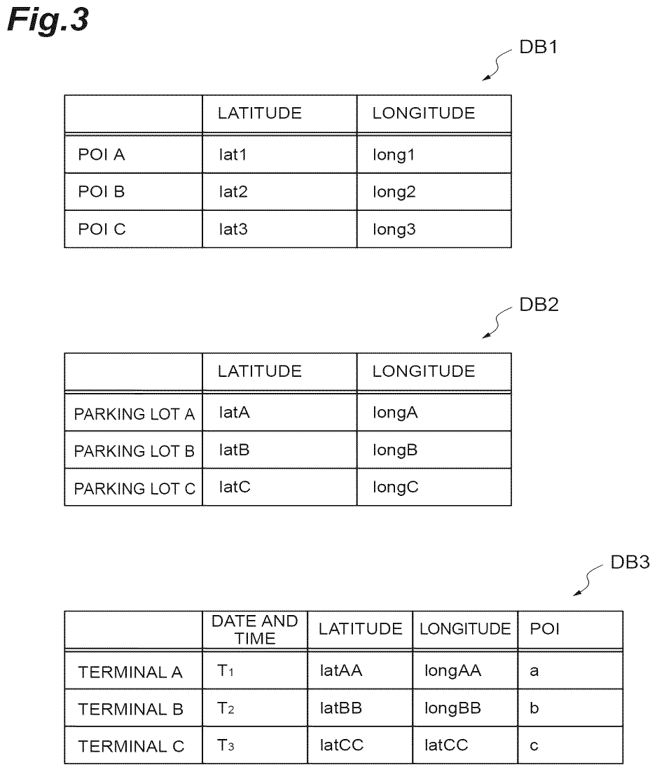

As shown in FIG. 3, the POI database DB1 stores information indicating the location of a POI (Point Of Interest). In this embodiment, the POI includes, for example, a place such as a tourist spot that may be visited by a person. The information indicating the location of the POI includes, for example, the latitude and longitude of the POI.

In this embodiment, the visiting place estimation unit 12 acquires information indicating the location of the POI with reference to the POI database DB1. The visiting place estimation unit 12 calculates a distance from the destination M to the POI based on the destination information and the information indicating the location of the POI. The visiting place estimation unit 12 estimates the location of the POI that is located within a predetermined distance from the destination M as the location of the estimated visiting place S based on the calculated distance. The predetermined distance is, for example, set in advance and can be changed as appropriate.

The visiting place estimation unit 12 may estimate the location of the estimated visiting place S to be visited by the user, based on destination information by a method other than the above-mentioned method, such as using a method of the related art. The visiting place estimation unit 12 may estimate the location of the estimated visiting place S based on, for example, preset attributes of the destination M and the POI. In addition, the location of the estimated visiting place S may be estimated depending on a user (using information of the user). In addition, the visiting place estimation unit 12 may statistically calculate the estimated visiting place S based on, for example, trajectory data of people who visited the same destination M in the past (collaborative filtering).

The parking lot information acquisition unit 13 shown in FIG. 1 acquires parking lot information indicating the location of the parking lot P. In this embodiment, with reference to a parking lot database DB2 to be described below, the information indicating the location of the parking lot P is acquired.

As shown in FIG. 3, the parking lot database DB2 stores information indicating the location of the parking lot P. The information indicating the location of the parking lot P includes the latitude and longitude of the parking lot P.

In this embodiment, the parking lot information acquisition unit 13 calculates a distance from the destination M to the parking lot P based on the destination information acquired by the destination information acquisition unit 11 and the information indicating the location of the parking lot P. The parking lot information acquisition unit 13 acquires the location of the parking lot P located within a predetermined distance from the destination M as parking lot information based on the calculated distance. The predetermined distance is, for example, set in advance and can be changed as appropriate. The parking lot information acquisition unit 13 may acquire information indicating the locations of all parking lots P from the parking lot database DB2 without using destination information.

A method of generating the POI database DB1 and the parking lot database DB2 is not particularly limited. The POI database DB1 and the parking lot database DB2 may be generated by a known method.

In this embodiment, the parking lot recommendation system 1 generates a visitor database DB3 to be described below. However, the generation of the visitor database DB3 may be executed outside the parking lot recommendation system 1.

As shown in FIG. 3, the visitor database DB3 stores information indicating a route taken by a person (hereinafter referred to as a “visitor”) who visited a POI in the past. In this embodiment, the information indicating the route includes the date and time (the time) when the visitor visited the POI, the latitude and longitude of the POI visited by the visitor, and the POI visited by the visitor. The visitor database DB3 stores information indicating a route for each terminal (for example, a smartphone) owned by the visitor.

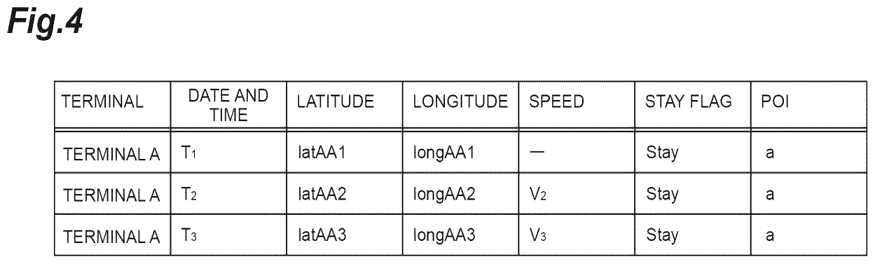

An example of a method of generating the visitor database DB3 will be described below with reference to FIG. 4. FIG. 4 shows an example in which information indicating a route of a visitor who owns a certain terminal A is generated. First, as described in the second to fourth columns from the left of a table, the parking lot recommendation system 1 acquires information indicating the date and time and the location of a visitor at that date and time. The information indicating the location of the visitor includes the latitude and longitude of terminal A. The parking lot recommendation system 1 may acquire information indicating the date and time and the location of the visitor at that date and time, for example, by periodically communicating with terminal A.

Subsequently, as shown in the fifth column from the left in the table, the parking lot recommendation system 1 calculates the moving speed based on the information indicating the date and time and the location of the visitor at that date and time. In this embodiment, the parking lot recommendation system 1 acquires a time change based on the date and time. The parking lot recommendation system 1 also acquires a moving distance based on the information indicating the location of the visitor at that date and time. The parking lot recommendation system 1 then calculates, as a moving speed, a value obtained by dividing the above-mentioned moving distance by the above-mentioned time change.

For example, the parking lot recommendation system 1 acquires a period of time from a certain date and time T₁ to a date and time T₂, which is later than T₁, as a time change. The parking lot recommendation system 1 acquires, as a moving distance, a distance from a point represented by the latitude and longitude of terminal A at T₁ to a point represented by the latitude and longitude of terminal A at T₂. The parking lot recommendation system 1 then calculates, as a moving speed, V₂ which is a value obtained by dividing the above-mentioned moving distance by the above-mentioned time change. The parking lot recommendation system 1 stores the calculated moving speed in the fifth column from the left in the table.

Subsequently, as described in the sixth column from the left in the table, the parking lot recommendation system 1 performs a stay determination for each date and time. The stay determination refers to determining whether a visitor is staying. The staying refers to, for example, staying at a specific point or in its vicinity for a predetermined period of time or more. As an example, when the following Formulas (1), (2), and (3) are satisfied, the parking lot recommendation system 1 determines that the visitor is staying between a certain date and time Tₙ and a certain date and time Tₘ that is later than Tₙ. In the following formulas, Thₜ is a predetermined threshold value for a time, Thᵥ is a predetermined threshold value for a speed, Vₖ is a moving speed at Tk, and k is a subscript corresponding to the date and time.

$${T}_{m} - {T}_{n} > {Th}_{t} \qquad ( 1 )$$

$${V}_{k} < {Th}_{v} \qquad ( 2 )$$

$$n \leq k \leq m \qquad ( 3 )$$

The values of Thₜ and Thᵥ mentioned above are, for example, set in advance and can be changed as appropriate. When the parking lot recommendation system 1 determines that the visitor is staying between Tₙ and Tₘ, it adds a stay flag to the sixth column from the left in the table.

Subsequently, the parking lot recommendation system 1 specifies a POI visited by the visitor, as described in the seventh column from the left in the table. The parking lot recommendation system 1 acquires information to which a stay flag has been added and which indicates the locations of the visitor at consecutive dates and times. Next, the parking lot recommendation system 1 calculates the centroid of the location of the visitor based on the acquired information indicating the locations of the visitor. Then, the parking lot recommendation system 1 specifies a POI closest to the centroid as the POI visited by the visitor with reference to the POI database DB1. The parking lot recommendation system 1 stores the specified POI in the seventh column from the left in the table. The parking lot recommendation system 1 repeats the above processing for each of a plurality of terminals. The parking lot recommendation system 1 also generates the visitor database DB3 by removing records that have no POI data (no stay flag) from the generated table shown in FIG. 4 and deleting the fifth and sixth columns from the left.

The parking lot determination unit 14 shown in FIG. 1 performs determination regarding a parking lot P to be recommended to a user with reference to a selection probability database DB4 to be described below. In this embodiment, the parking lot determination unit 14 generates the selection probability database DB4.

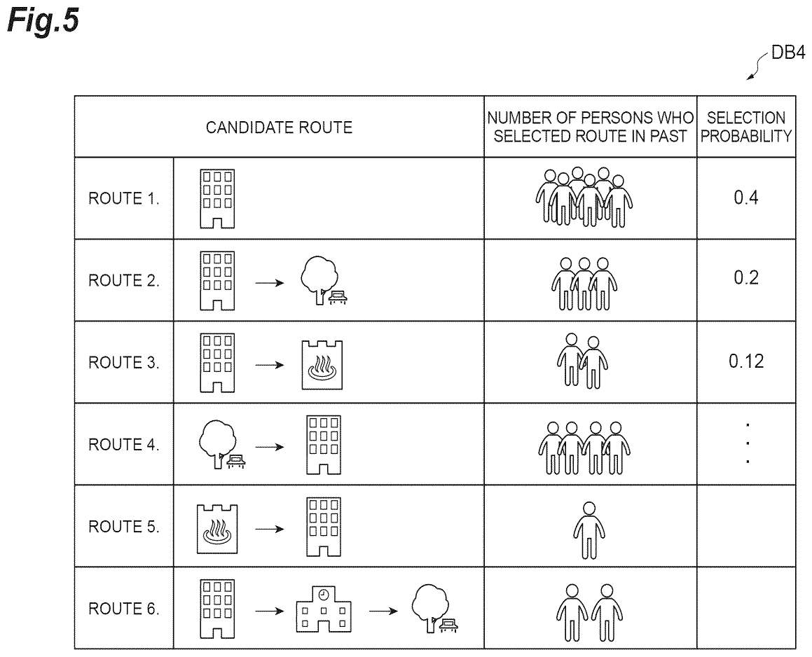

FIG. 5 is a diagram showing an example of a table stored in the selection probability database DB4. The selection probability database DB4 stores, for each candidate route to be described below, the number of visitors who selected the candidate route in the past, and an index value indicating the degree to which users will select the candidate route. In this embodiment, the index value is a selection probability. The selection probability is a ratio of the number of visitors who selected each candidate route to the total number of visitors who selected candidate routes in the past.

An example of a method of generating the selection probability database DB4 will be described below with reference to FIG. 5. First, as shown in the first and second columns from the left in the table of the selection probability database DB4, the parking lot determination unit 14 calculates a plurality of candidate routes. A candidate route is a candidate for the order in which a user will visit a destination M and an estimated visiting place S. However, the candidate routes may also include a candidate that does not visit any estimated visiting place S (a candidate that visits only the destination M).

More specifically, the parking lot determination unit 14 calculates a plurality of candidate routes based on destination information acquired by the destination information acquisition unit 11 and estimated visiting places S estimated by the visiting place estimation unit 12. For example, the parking lot determination unit 14 generates all combinations of estimated visiting places S (also including combinations that do not include estimated visiting places S). The parking lot determination unit 14 calculates, as candidate routes, all permutations of combinations in which the destination M is added to each combination. The parking lot determination unit 14 may calculate a plurality of candidate routes such that the number of estimated visiting places S included in a candidate route is equal to or less than a predetermined maximum number, so that the total number of candidate routes does not become enormous. In this case, the maximum number may be set in advance, for example, and may be changeable as appropriate. This prevents the amount of calculation from becoming excessive. The parking lot determination unit 14 may calculate a candidate route using a method other than the above-mentioned method. The parking lot determination unit 14 stores the calculated candidate route in the second column from the left in the table.

In this embodiment, the parking lot determination unit 14 acquires route information indicating a route of a person who visited the destination M in the past among visitors. More specifically, the parking lot determination unit 14 acquires (calculates) information indicating visitors who visited POIs that include the destination M from the generated visitor database DB3 (see FIG. 3) based on the destination information acquired by the destination information acquisition unit 11. Based on the acquired information, the parking lot determination unit 14 acquires the order of the POIs visited by the visitor as route information. It is assumed that the order of the POIs acquired as the route information from the visitor database DB3 corresponds to the sequence in which the visitor visited the POIs during a series of movements. For example, when a time interval between visits of consecutive POIs is equal to or less than a predetermined value that is set in advance, it is assumed that those POIs have been visited by in a series of movements.

Subsequently, as shown in the third column from the left in the table, the parking lot determination unit 14 acquires the number of persons who selected each candidate route in the past among visitors. More specifically, the parking lot determination unit 14 specifies persons who have followed the calculated candidate route among visitors based on the acquired route information. For example, the parking lot determination unit 14 specifies persons who have visited the destination M and the estimated visiting place S included in the candidate route in the order of the calculated permutation as persons who have followed the candidate route. The parking lot determination unit 14 calculates the number of persons who have followed the specified candidate route. The parking lot determination unit 14 stores the calculated number of persons in the third column from the left in the table.

Subsequently, as shown in the fourth column from the left in the table, the parking lot determination unit 14 calculates an index value (selection probability) of each candidate route. The parking lot determination unit 14 acquires an index value for each of the plurality of candidate routes based on the route information. More specifically, based on the calculated number of persons, the parking lot determination unit 14 calculates, as a selection probability, a ratio of the number of visitors who selected each candidate route to the total number of visitors who selected the candidate routes in the past. The parking lot determination unit 14 stores the calculated selection probability in the fourth column from the left in the table. The parking lot determination unit 14 generates a selection probability database DB4 through the above processing.

In this embodiment, the parking lot recommendation system 1 stores the POI database DB1, the parking lot database DB2, the visitor database DB3, and the selection probability database DB4. However, the POI database DB1, the parking lot database DB2, the visitor database DB3, and the selection probability database DB4 may be stored outside the parking lot recommendation system 1.

The parking lot determination unit 14 performs determination regarding a parking lot P to be recommended to a user based on movement along a route including the location of the destination M indicated by the destination information acquired by the destination information acquisition unit 11, the location of the estimated visiting place S estimated by the visiting place estimation unit 12, and the location of the parking lot P indicated by the parking lot information acquired by the parking lot information acquisition unit 13.

The parking lot determination unit 14 performs determination regarding a parking lot P based on, for example, an evaluation value. In this embodiment, the parking lot determination unit 14 acquires a selection probability of each candidate route as an evaluation value with reference to the selection probability database DB4. The parking lot determination unit 14 performs determination regarding a parking lot P based on the acquired selection probability. In addition, the parking lot determination unit 14 acquires, as an evaluation value, a distance of a walking route including the location of the destination M, the location of the estimated visiting place S, and the location of the parking lot P based on the destination information, the location of the estimated visiting place S, and the parking lot information. The parking lot determination unit 14 performs determination regarding a parking lot P based on the acquired distance.

In this embodiment, the parking lot determination unit 14 calculates, as a predicted route that is predicted to be followed by a user, a candidate route that has a higher selection probability than a predetermined value among the calculated candidate routes. The predetermined value is, for example, set in advance, and is 0.05 as an example. The predetermined value can be changed as appropriate. The parking lot determination unit 14 calculates a walking route that includes the location of the destination M and the location of the estimated visiting place S, that are included in the calculated predicted route, and the location of the parking lot P indicated by the parking lot information. More specifically, the parking lot determination unit 14 calculates, as a walking route, a route that starts from the parking lot P, visits all visiting places (the destination M and the estimated visiting place S) in the order of the candidate route, and returns to the parking lot P again, based on, for example, the geographical positions of roads stored in a database in advance. However, the parking lot determination unit 14 may calculate a route other than the above-mentioned route as a walking route. The parking lot determination unit 14 calculates a walking distance when moving along the calculated walking route based on the geographical positions of the roads stored in the database in advance.

In this embodiment, based on the calculated walking distance, the parking lot determination unit 14 determines a parking lot P included in a walking route where the walking distance is equal to or less than a predetermined distance as a parking lot P to be recommended to a user (hereinafter referred to as a “recommended parking lot”). The predetermined distance is set in advance, for example, and is 100 m as an example. The predetermined distance can be changed as appropriate.

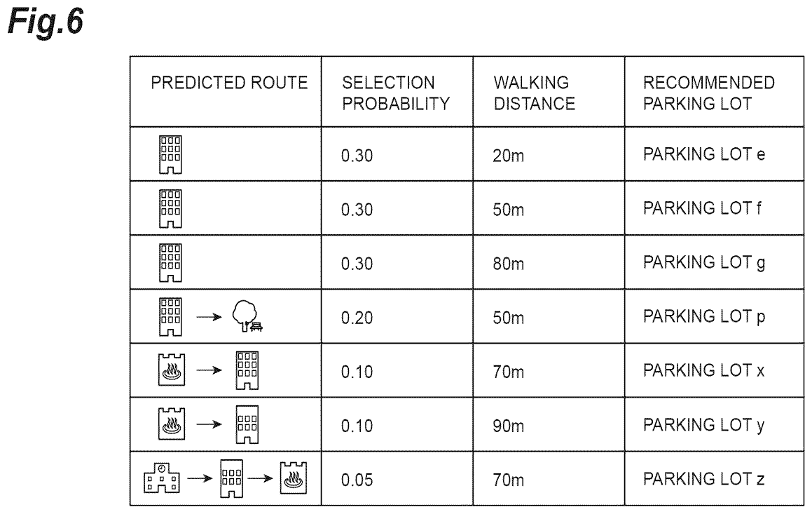

The parking lot determination unit 14 outputs information indicating the determined recommended parking lot. In this embodiment, the parking lot determination unit 14 transmits the information indicating the recommended parking lot to the user terminal 2 as an output. The user terminal 2 that receives the information indicating the recommended parking lot displays the information indicating the recommended parking lot. The information indicating the recommended parking lot is information that specifies a selection probability, walking distance, and recommended parking lot for each predicted route calculated as shown in FIG. 6.

FIG. 6 is a diagram showing an example of the display of recommended parking lots. The parking lot determination unit 14 displays, for example, predicted routes with a high selection probability in order from the top. The parking lot determination unit 14 displays, in order from the top, parking lots P included in walking routes with short walking distances among walking routes that include a destination M and an estimated visiting place S included in predicted routes with the same selection probability. However, the parking lot determination unit 14 may display, for example, determined recommended parking lots on the user terminal 2 in no order. Information indicating recommended parking lots may be output by a method other than the above-mentioned method. The output information indicating the recommended parking lots may be any information other than the above-mentioned information as long as the information is related to determination regarding a parking lot P to be recommended to a user.

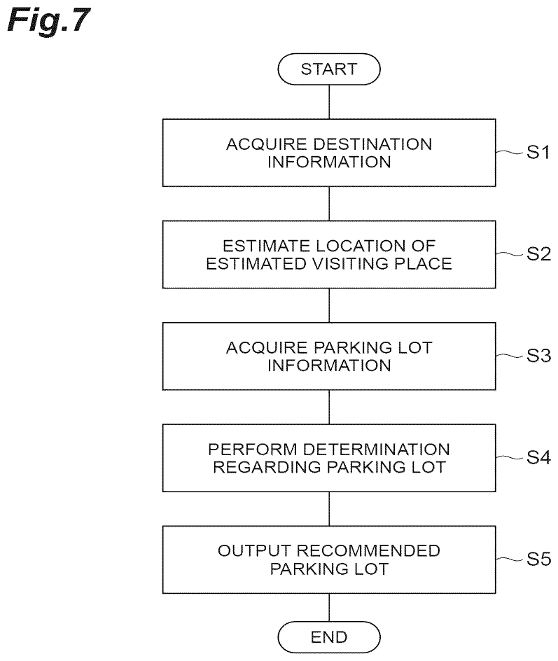

Subsequently, processing executed by the parking lot recommendation system 1 according to this embodiment will be described using a flowchart in FIG. 7. FIG. 7 is a flowchart showing an example of the operation of the parking lot recommendation system 1 according to this embodiment. In this processing, destination information is input to the user terminal 2 by the user.

Subsequently, the destination information acquisition unit 11 acquires destination information (step S1). In step S1, the destination information acquisition unit 11 receives and acquires the destination information from the user terminal 2.

Next, the visiting place estimation unit 12 estimates the location of an estimated visiting place S (step S2). In step S2, the visiting place estimation unit 12 estimates the location of the estimated visiting place S based on the destination information acquired by the destination information acquisition unit 11. The visiting place estimation unit 12 acquires information indicating the location of a POI with reference to the POI database DB1. The visiting place estimation unit 12 calculates a distance from a destination M to the POI based on the destination information and the information indicating the location of the POI. Based on the calculated distance, the visiting place estimation unit 12 estimates the location of the POI located within a predetermined distance from the destination M as the location of the estimated visiting place S.

Subsequently, parking lot information is acquired by the parking lot information acquisition unit 13 (step S3). In step S3, the parking lot information acquisition unit 13 acquires information indicating the location of a parking lot P with reference to the parking lot database DB2. The parking lot information acquisition unit 13 calculates a distance from the destination M to the parking lot P based on the destination information and the information indicating the location of the parking lot P. Based on the calculated distance, the parking lot information acquisition unit 13 acquires, as parking lot information, the location of the parking lot P that is located within a predetermined distance from the destination M.

Subsequently, the parking lot determination unit 14 performs determination regarding a parking lot P (step S4). In step S4, the parking lot determination unit 14 performs determination regarding a parking lot P to be recommended to a user based on movement along a route including the location of the destination M indicated by the destination information acquired by the destination information acquisition unit 11, the location of the estimated visiting place S estimated by the visiting place estimation unit 12, and the location of the parking lot P indicated by the parking lot information acquired by the parking lot information acquisition unit 13.

In step S4, the parking lot determination unit 14 generates the above-mentioned selection probability database DB4. The parking lot determination unit 14 calculates a plurality of candidate routes based on destination information acquired by the destination information acquisition unit 11 and estimated visiting places S estimated by the visiting place estimation unit 12. The parking lot determination unit 14 acquires a selection probability of each candidate route as an evaluation value with reference to the selection probability database DB4. Based on the acquired selection probability, the parking lot determination unit 14 calculates, as a predicted route, a candidate route that has a higher selection probability than a predetermined value among the calculated candidate routes.

In step S4, the parking lot determination unit 14 calculates a walking distance when moving along the walking route that includes the location of the destination M and the location of the estimated visiting place S, that are included in the calculated predicted route, and the location of the parking lot P indicated by the parking lot information. Based on the calculated walking distance, the parking lot determination unit 14 determines, as a recommended parking lot, a parking lot P included in a walking route where the walking distance is equal to or less than a predetermined distance.

Subsequently, the parking lot determination unit 14 outputs information indicating the determined recommended parking lot (step S5). In step S5, the parking lot determination unit 14 transmits the information indicating the recommended parking lot to the user terminal 2 as an output. The user terminal 2 that receives the information indicating the recommended parking lot displays the information indicating the recommended parking lot.

The parking lot determination unit 14 displays, in order from the top, predicted routes with a high selection probability. The parking lot determination unit 14 displays, in order from the top, parking lots P included in walking routes with short walking distances among walking routes that include a destination M and an estimated visiting place S included in predicted routes with the same selection probability. The above is processing executed by the parking lot recommendation system 1 according to this embodiment.

When recommending a parking lot P to a user, not only the location of a destination M but also a positional relationship involving an estimated visiting place S and the parking lot P should be taken into consideration. However, a typical navigation system assumes that the location of a single destination is input, making it difficult for the system to acquire the locations of a plurality of estimated visiting places S. For this reason, it has been difficult to recommend a parking lot P that takes into consideration a positional relationship involving an estimated visiting place S and the parking lot P.

In this embodiment, determination regarding a parking lot P to be recommended to a user is performed based on movement along a route including the location of a user's destination M, the location of an estimated visiting place S, and the location of the parking lot P. For example, determination regarding a parking lot P to be recommended to a user can be performed to reduce the burden when moving along a route including the location of the destination M, the location of the estimated visiting place S, and the location of the parking lot P. Since determination regarding a parking lot P can be performed in consideration of all positional relationships between the destination M, the estimated visiting place S, and the parking lot P, an appropriate parking lot P can be recommended to the user.

Furthermore, as in this embodiment, the parking lot determination unit 14 may acquire candidate routes which are candidates for the order in which the user will visit the destination M and the estimated visiting place S, based on the location of the estimated visiting place S estimated by the visiting place estimation unit 12. In this case, the candidate routes can be acquired by taking into account the location of the estimated visiting place S, and thus candidate routes can be acquired in consideration of the user's visiting to not only the destination M but also the estimated visiting place S. As a result, it is possible to recommend a route that is appropriate for the user.

Furthermore, as in this embodiment, the parking lot determination unit 14 may acquire route information indicating the routes visited by persons (visitors) who visited a destination M in the past, acquire an index value indicating the degree to which a user selects a route for each of a plurality of candidate routes based on the route information, and perform determination regarding a parking lot P based on the acquired index value. In this case, determination regarding a parking lot P to be recommended to a user is performed by taking into account the routes of persons who visited the destination M in the past, and thus a more appropriate parking lot P can be recommended to the user. Note that the index value may be something other than the above-mentioned selection probability, as long as it indicates the degree to which a user selects a route.

Furthermore, as in this embodiment, the parking lot determination unit 14 may perform determination regarding a parking lot P based on a distance of a route including the location of a destination M, the location of an estimated visiting place S, and the location of the parking lot P. In this case, for example, determination regarding a parking lot P can be performed to reduce the burden of movement along the route on the user, and thus a more appropriate parking lot P can be recommended to the user.

The configuration and processing of the parking lot recommendation system 1 described in the above-described embodiment are merely examples, and various modifications can be made. Representative modification examples will be described below.

In the above-described embodiment, an example has been described in which the parking lot determination unit 14 performs determination regarding a parking lot P based on a distance of a route including the location of a destination M, the location of an estimated visiting place S, and the location of a parking lot P. However, the parking lot determination unit 14 may perform determination regarding a parking lot P based on a time required to move along the route including the location of the destination M, the location of the estimated visiting place S, and the location of the parking lot P. In this case, the parking lot determination unit 14 may acquire, as the above-mentioned required time, a value obtained by dividing the distance of the route by the user's walking speed, and determine, as a recommended parking lot, a parking lot P with the shortest required time acquired. The user's walking speed is, for example, set in advance and can be changed as appropriate.

In the above embodiment, the parking lot determination unit 14 calculates, as a predicted route, a candidate route having a higher selection probability than a predetermined value among calculated candidate routes. However, the parking lot determination unit 14 may calculate, as predicted routes, a predetermined number of candidate routes from among the calculated candidate routes, starting from the candidate route having the highest selection probability. Also in the above embodiment, the parking lot determination unit 14 determines, as a recommended parking lot, a parking lot P included in a walking route in which the calculated walking distance is equal to or less than a predetermined distance based on the walking distance. However, the parking lot determination unit 14 may determine, as recommended parking lots, a predetermined number of parking lots P in order from a parking lot P included in a walking route in which the calculated walking distance is shortest. That is, in addition to or instead of determining a parking lots to be recommended to the user, the parking lot determination unit 14 may determine the order of parking lots to be recommended to the user.

In addition, the parking lot determination unit 14 may perform determination regarding a parking lot to be recommended to the user in a manner other than that described above, as long as it is based on movement along a route that includes the location of a destination M, the location of an estimated visiting place S, and the location of a parking lot.

The contents of the POI database DB1, the parking lot database DB2, the visitor database DB3, the selection probability database DB4, and the road database described above are merely examples, and are not limited to those described above.

Note that the block diagrams used to describe the above-described embodiment show blocks of functional units. These functional blocks (configuration units) are implemented by at least one arbitrary combination of hardware and software. In addition, a method of implementing each functional block is not particularly limited. That is, each functional block may be implemented by using one device that is combined physically or logically or using a plurality of devices by directly or indirectly (for example, using a wire or wirelessly) connecting two or more devices separated physically or logically. A functional block may be implemented by combining software with one device or a plurality of devices described above.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (configuration unit) enabling transmission to function is referred to as a transmitting unit or a transmitter. In either case, as described above, implementation methods are not particularly limited.

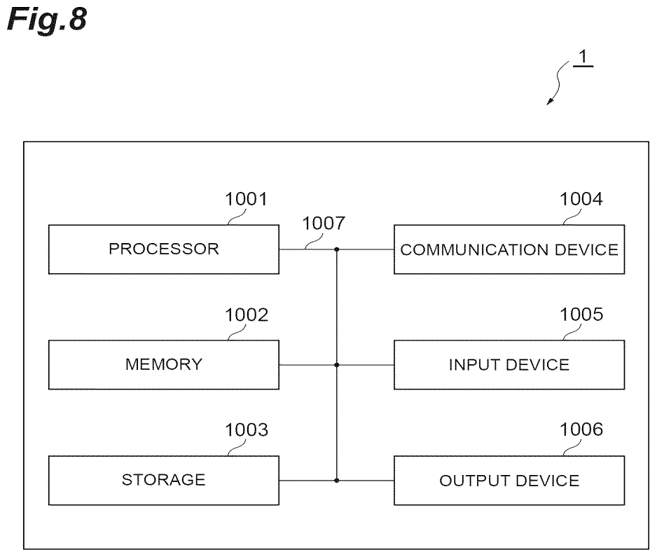

For example, the parking lot recommendation system 1 in an embodiment of the present disclosure may function as a computer that performs information processing according to the present disclosure. FIG. 8 is a diagram showing an example of a hardware configuration of the parking lot recommendation system 1 according to an embodiment of the present disclosure. The above-mentioned parking lot recommendation system 1 may be physically configured as a computer device including a processor 1001, a memory 1002, a storage 1003, a communication device 1004, an input device 1005, an output device 1006, a bus 1007, and the like. The hardware configuration of the terminal 20 may also be as described here.

Note that, in the following description, a term “device” may be rephrased as a circuit, a device, a unit, or the like. The hardware configuration of the parking lot recommendation system 1 may be configured to include one or a plurality of devices shown in the drawings, or may be configured without including some of the devices.

The processor 1001 performs an arithmetic operation by reading predetermined software (program) onto hardware such as the processor 1001 or the memory 1002, and thus each function in the parking lot recommendation system 1 is implemented by controlling communication in the communication device 1004 or controlling at least one of reading-out and writing of data in the memory 1002 and the storage 1003.

The processor 1001, for example, controls the entire computer by operating an operating system. The processor 1001 may be configured with a central processing unit (CPU) including an interface with peripheral devices, a control device, an arithmetic device, a register, and the like. For example, each function in the above-described parking lot recommendation system 1 may be implemented by the processor 1001.

In addition, the processor 1001 reads a program (program code), a software module, data, or the like from at least one of the storage 1003 and the communication device 1004 to the memory 1002 and executes various processes in accordance therewith. As the program, a program that causes a computer to execute at least some of the operations described above in the embodiment is used. For example, each function in the parking lot recommendation system 1 may be implemented by a control program which is stored in the memory 1002 and operates in the processor 1001. The various processes described above are described as being executed by a single processor 1001, but they may be simultaneously or sequentially executed by two or more processors 1001. The processor 1001 may be mounted as one or more chips. Note that the program may be transmitted from a network via an electrical communication line.

The memory 1002 is a computer-readable recording medium and may be configured with, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store an executable program (program code), a software module, or the like that can be executed to perform information processing according to an embodiment of the present disclosure.

The storage 1003 is a computer-readable recording medium and may be configured with, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage medium included in the parking lot recommendation system 1 may be, for example, a database including at least one of the memory 1002 and the storage 1003, a server, or other appropriate media.

The communication device 1004 is hardware (transmitting and receiving device) that performs communication between computers via at least one of a wired and wireless network and is also referred to as, for example, a network device, a network controller, a network card, or a communication module.

The input device 1005 is an input device (for example, a keyboard, a mouse, a microphone, a switch, buttons, a sensor, or the like) that receives an input from the outside. The output device 1006 is an output device (for example, a display, a speaker, an LED lamp, or the like) that performs output to the outside. Note that the input device 1005 and the output device 1006 may have an integrated configuration (for example, a touch panel).

In addition, the devices such as the processor 1001 and the memory 1002 are connected to each other via the bus 1007 for communication of information. The bus 1007 may be configured using a single bus, or may be configured using different buses between devices.

In addition, the parking lot recommendation system 1 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of the processing procedures, the sequences, the flowcharts, and the like of the aspects/embodiments described above in the present disclosure may be changed unless conflictions arise. For example, in the methods described in the present disclosure, various steps are presented as elements of an exemplary order, but the methods are not limited to the presented specific order.

Information or the like which is input or output may be stored in a specific place (for example, a memory) or may be managed using a management table. Information or the like which is input or output may be overwritten, updated, or added. The output information and the like may be deleted. The input information and the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in the present disclosure may be used alone, may be used in combination, or may be switched during implementation thereof. In addition, a notification of predetermined information (for example, a notification of “being X”) is not limited to being performed explicitly and may be performed implicitly (for example, a notification of the predetermined information is not performed).

Although the present disclosure has been described above in detail, it is apparent to a person skilled in the art that the present disclosure is not limited to the embodiments described in the present disclosure. The present disclosure may be modified or changed without departing from the gist and the scope of the present disclosure set in accordance with the claims. Thus, the description presented in the present disclosure is for the purpose of exemplary description and does not have any limited meaning for the present disclosure.

Software, regardless whether it is referred to as software, firmware, middleware, a microcode, a hardware description language, or any other name, should be widely interpreted to mean a command, a command set, a code, a code segment, a program code, a program, a subprogram, a software module, an application, a software application, a software package, a routine, a subroutine, an object, an executable file, an execution thread, a procedure, a function, and the like.

In addition, software, a command, information, and the like may be transmitted and received via a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining”. In addition, “determining” may include a case in which receiving (for example, receiving information), transmitting (for example, transmitting information), input, output, or accessing (for example, accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased as “assuming”, “expecting”, “considering”, and the like.

The terms “connected” and “coupled” and every modification thereof refer to direct or indirect connection or coupling between two or more elements and can include that one or more intermediate elements are present between two elements “connected” or “coupled” to each other. The coupling or connecting of elements may be physical, may be logical, or may be a combination thereof. For example, “connection” may be read as “access.” When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

The expression “based on” used in the present disclosure does not mean “based on only” unless otherwise described. In other words, description of “based on” means both “based on only” and “based on at least”.

Any referring to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are adopted therein or the first element precedes the second element in a certain form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other”. Note that the expression may mean that “A and B are different from C.” Expressions such as “separated” and “coupled” may be construed in the same manner as “different.”

The parking lot recommendation system according to the present disclosure has the following configurations.

[1] A parking lot recommendation system including:
a destination information acquisition unit that acquires destination information indicating a location of a user's destination;
a visiting place estimation unit that estimates a location of an estimated visiting place to be visited by the user based on the destination information;
a parking lot information acquisition unit that acquires parking lot information indicating a location of a parking lot; and
a parking lot determination unit that performs determination regarding the parking lot to be recommended to the user, based on movement along a route including the location of the destination indicated by the destination information, the location of the estimated visiting place, and the location of the parking lot indicated by the parking lot information.
   [2] The parking lot recommendation system according to [1], in which the parking lot determination unit acquires candidate routes that are candidates for an order in which the user visits the destination and the estimated visiting place, based on the location of the estimated visiting place estimated by the visiting place estimation unit.
   [3] The parking lot recommendation system according to [2], in which the parking lot determination unit
acquires route information indicating a route of a person who visited the destination in the past,
acquires an index value indicating a degree to which the user selects a route for each of the plurality of candidate routes, based on the route information, and
performs determination regarding the parking lot based on the acquired index value.
   [4] The parking lot recommendation system according to any one of [1] to [3], in which the parking lot determination unit performs determination regarding the parking lot based on a distance of a route including the location of the destination, the location of the estimated visiting place, and the location of the parking lot.

### REFERENCE SIGNS LIST

1 Parking lot recommendation system, 11 Destination information acquisition unit, 12 Estimated visiting place, 13 Parking lot information acquisition unit, 14 Parking lot determination unit, M Destination, P Parking lot, S Estimated visiting place

1. A parking lot recommendation system comprising circuitry configured to:
acquire destination information indicating a location of a user's destination;
estimate a location of an estimated visiting place to be visited by the user based on the destination information;
acquire parking lot information indicating a location of a parking lot; and
perform determination regarding the parking lot to be recommended to the user, based on movement along a route including the location of the destination indicated by the destination information, the location of the estimated visiting place, and the location of the parking lot indicated by the parking lot information.

2. The parking lot recommendation system according to claim 1, wherein the circuitry acquires candidate routes that are candidates for an order in which the user visits the destination and the estimated visiting place, based on the location of the estimated visiting place.

3. The parking lot recommendation system according to claim 2, wherein the circuitry
acquires route information indicating a route of a person who visited the destination in the past,
acquires an index value indicating a degree to which the user selects a route for each of the plurality of candidate routes, based on the route information, and
performs determination regarding the parking lot based on the acquired index value.

4. The parking lot recommendation system according to claim 1, wherein the circuitry performs determination regarding the parking lot based on a distance of a route including the location of the destination, the location of the estimated visiting place, and the location of the parking lot.
